(19) United States
(12) Patent Application Publication
(10) Pub. No.: US 2026/0318736 A1
(43) Pub. Date: Oct. 15, 2026

(54) SYSTEM AND METHOD FOR QUANTUM KEY DISTRIBUTION (QKD)

(71) Applicants: Quantum Industries GmbH, Vienna (AT); Quantum Technology Laboratories GmbH, Vienna (AT)

(72) Inventors: Sebastian NEUMANN, Vienna (AT); Matthias FINK, Neulengbach (AT)

(21) Appl. No.: 19/465,545

(22) Filed: Jan. 30, 2026

(30) Foreign Application Priority Data
Jan. 31, 2025 (DE) 10 2025 103 708.6

(51) Int. Cl. G01J 1/44; G01J 1/04

(52) U.S. Cl. CPC G01J 1/44; G01J 1/0425; G01J 1/0429; G01J 2001/442

(57) ABSTRACT

A quantum key distribution (QKD) system having an entangled photon source for generating polarization-entangled photon pairs, a first receiver and a second receiver, wherein each polarization-entangled photon pair consists of a signal photon and an idler photon, and wherein the first receiver is connected via a first communication channel to the entangled photon source for transmitting the signal photons or the idler photons, wherein the first receiver comprises a first detection unit, and wherein the second receiver is connected via a second communication channel to the entangled photon source for transmitting the idler photons or the signal photons, wherein the second receiver comprises a demultiplexer and at least one second detection unit, wherein the demultiplexer divides the idler photons or the signal photons according to their wavelength onto at least two outputs of the demultiplexer, and wherein a polarization compensation unit is arranged after each output of the demultiplexer.

### CROSS-REFERENCE TO RELATED APPLICATION

This application is a Submission Under 35 U.S.C. § 111(a) which claims priority to German Application No.: 10 2025 103 708.6, filed Jan. 31, 2025, entitled “SYSTEM AND METHOD FOR QUANTUM KEY DISTRIBUTION (QKD),” the entirety of which is incorporated herein by reference.

### DESCRIPTION

The present invention relates to a system and method for quantum key distribution (QKD). In quantum key distribution (QKD), individual photons or entangled photon pairs are used for secure and robust communication between two receivers. The generation of a key between the two receivers for encrypting and decrypting messages and the ability to detect the presence of a third party attempting to gain knowledge of the generated key is essential.

The advantage of quantum key distribution over classical key distribution methods is that the security achieved is based on known physical laws and not on assumptions about the performance of computers and algorithms or the reliability of trusted parties.

In known systems, the polarization-entangled photons are transmitted via telecommunications fibers, which enables the implementation of quantum communication protocols in the existing infrastructure. Fiber-internal communication enables the continuous establishment of quantum communication in an environment that is not affected by weather, time of day, or urban light pollution. However, during transmission in fiber optic cable, the polarization of the photons is rotated in an unknown manner, which must be compensated for in quantum key distribution by a polarization compensation unit so that both receivers measure in the same bases to generate a key.

To generate polarization-entangled photon pairs, a (highly birefringent) nonlinear crystal is pumped with a laser to generate photon pairs by means of parametric fluorescence (spontaneous parametric down-conversion SPDC). In quantum key distribution (QKD) with polarization-entangled photon pairs based on parametric fluorescence (SPDC), there is a trade-off between the generation rate G of the polarization-entangled photon pairs and the quality of the entangled state.

The quality of the entangled state is influenced, among other things, by what is known as multi-pair emission, which (in a first approximation) scales quadratically with the photon pair generation rate. An emission event is said to be a multi-pair event if two or more photon pairs are emitted within a time interval that is smaller than the temporal resolution of the detection system.

Since multi-pair events increase the quantum bit error rate (QBER) during quantum key distribution, they limit the maximum possible photon pair generation rate of the entangled photon sources depending on the temporal resolution of the detection system. The quantum bit error rate (QBER) is a measure of the error rate in quantum communication systems and, in particular, indicates the number of incorrectly received bits compared to the total number of bits sent. The quantum bit error rate (QBER) is crucial for evaluating the reliability of quantum key distribution (QKD) protocols, as it indicates how well the system can preserve the integrity of the transmitted quantum information against noise and eavesdrop-ping attempts. An optimal generation rate G is approximately equal to G=1/(10*tᵣₑₛ) with tᵣₑₛ as the temporal resolution of the detection system.

The best detectors currently available for photons with telecommunications wavelengths are superconducting nanowire single-photon detectors (SNSPD) with a temporal resolution of a few picoseconds. However, known entangled photon sources can generate enough photon pairs to surpass the optimal generation rate for superconducting nanowire single-photon detectors (SNSPD) within a single ITU channel pair.

Another challenge for quantum key distribution (QKD) with polarization-entangled photon pairs is the fact that the source may be located close to one of the receivers, while the other receiver is connected to the source via a long fiber. In such a scenario, if the source is operated at the optimal high generation rate G required to overcome the losses along the fiber, this leads to saturation of the detection system of the near receiver. Therefore, either the additional losses due to saturation must be accepted, or the source must be operated below the optimal generation rate G to avoid saturation at the nearby receiver. Both cases result in a significant reduction in the key generation rate.

Based on this problem, the invention is thus aimed at providing a system and method for quantum key distribution (QKD) with an improved key generation rate.

The object of the invention is solved by a system for quantum key distribution (QKD) according to independent claim 1, with advantageous further developments of the inventive system for quantum key distribution (QKD) being specified in the dependent claims.

Accordingly, the invention relates in particular to a system for quantum key distribution (QKD) comprising an entangled photon source for generating polarization-entangled photon pairs, a first receiver and a second receiver,
wherein each polarization-entangled photon pair consists of a signal photon and an idler photon, and
wherein the first receiver is connected via a first communication channel to the entangled photon source for transmitting the signal photons or the idler photons, wherein the first receiver has a first detection unit, and
wherein the second receiver is connected via a second communication channel to the entangled photon source for transmitting the idler photons or the signal photons, wherein the second receiver comprises a demultiplexer and at least one second detection unit, wherein the demultiplexer divides the idler photons or the signal photons according to their wavelength onto at least two outputs of the demultiplexer, and wherein a polarization compensation unit is arranged after each output of the demultiplexer.

The system according to the invention has the advantage of an improved key generation rate, since the at least two polarization compensation units enable better compensation for the rotation of the polarization in all communication channels.

A prerequisite for generating a key in quantum key distribution (QKD) is that both receivers agree on two common mutually unbiased bases (MUB). This means that each polarization vector on the Poincare sphere in the reference system of the first receiver is mapped to a known counterpart on the Poincare sphere at the second receiver. However, when photons are transmitted in fiber optics, their polarization is rotated in an unknown manner, which can be compensated for in quantum key distribution by a polarization compensation unit. If both receivers agree on the same reference system, this is equivalent to compensation for the unitary transformations of polarization between the two receivers. For example, polarization compensation can be performed by a polarization compensation unit in the H/V basis (H horizontal linear polarization and V vertical linear polarization) and in a second, non-orthogonal measurement basis (e.g., D=H+V diagonal linear polarization and A=H−V anti-diagonal linear polarization).

At least one second detection unit of the second receiver means here that the second receiver has one, or two, or three, or four, or five or more detection units.

In an alternative further development, a multiplexer may be provided upstream of the at least one second detection unit to combine the demultiplexed photons onto the at least one second detection unit, wherein the multiplexer is arranged downstream of the at least two polarization compensation units. At least one second detection unit means a second detection unit, or two second detection units, or three second detection units, or four second detection units, or more second detection units. In the case of a multiplexer, several second detection units may also be formed at the second receiver, in which case at least one of the second detection units is assigned to several outputs of the demultiplexer for measuring the photons.

The multiplexer has the advantage that, on the one hand, improved polarization compensation is possible due to the at least two polarization compensation units, and at the same time, a cost-effective system with only a few detection units can be provided.

In an alternative further development, it may be provided that at least two second detection units are formed at the second receiver, with a polarization compensation unit being arranged in front of each of the second detection units. In particular, a second detection unit may be formed at the second receiver for each output of the demultiplexer.

The system according to the invention with at least two second detection units has the advantage of an improved key generation rate, in that the source can be operated at an optimal generation rate G without saturation of the detection units at the second receiver, since the spectrum of the generated idler photons or signal photons is distributed among the multiple detection units. Another advantage is that, despite a broad spectrum, only one communication channel is required to transmit the photons from the source to the second receiver, which saves costs.

In addition, in all embodiments, only one detection unit at the first receiver is sufficient, which leads to a further cost reduction.

The following describes that the signal photon is transmitted to the first receiver and the idler photon is transmitted to the second receiver. It is of course clear that the idler photon can be transmitted to the first receiver instead of the signal photon, in which case the signal photon is transmitted to the second receiver. This applies to all subsequent alternative further developments.

In an alternative development, it may be provided that the first receiver comprises only the first, preferably only the one first, detection unit.

In an alternative further development, it may be provided that the entangled photon source comprises a laser and a nonlinear element for generating polarization-entangled photon pairs, or that the entangled photon source comprises a quantum dot for generating polarization-entangled photon pairs.

In an alternative further development, it may be provided that the transmission rate of the idler photons from the entangled photon source to the second receiver is greater than the transmission rate of the signal photons from the entangled photon source to the first receiver, and/or
that the losses of the signal photons from the entangled photon source to the first receiver are greater than the losses of the idler photons from the entangled photon source to the second receiver, and/or that the first communication channel is longer than the second communication channel, and/or that the entangled photon source is located in the immediate vicinity of the second receiver. The greater losses and also the lower transmission rate can be achieved by a longer first communication channel or by the choice of material for the communication channels or by the choice of wavelengths of the photons. In the immediate vicinity means that the second receiver is within the sphere of influence of the source, for example in the same room or in the same building.

It may be provided that the losses, preferably in the first communication channel, amount to more than 20 dB, preferably more than 30 dB, preferably more than 50 dB. It may be provided that the losses in the first communication channel amount to more than 20 dB, preferably more than 30 dB, preferably more than 50 dB, than the losses in the second communication channel.

In an alternative further development, it may be provided that the demultiplexer is designed as a wavelength-splitting element, preferably as one or more dichroic mirrors, or grating, or prism, or etalon, or fiber etalon, in order to split the idler photons according to their wavelength onto the multiple outputs of the demultiplexer and thus onto the multiple polarization compensation units. In this embodiment, the demultiplexer splits the photons from the second communication channel according to their wavelength onto multiple outputs. In an alternative further development, it may be provided that the demultiplexer has one input, preferably only one input, and at least two outputs, preferably one output per polarization compensation unit. At least two outputs here means that the second demultiplexer has two, or three, or four, or five or more outputs.

In an alternative further development, it may be provided that the multiplexer is designed as a wavelength-combining element, preferably as one or more dichroic mirrors, or gratings, or prisms, etalons, or fiber etalons, in order to combine the idler photons of different wavelengths in one output of the multiplexer.

In an alternative further development, it may be provided that each output of the demultiplexer is connected to one of the at least one second detection units, preferably via a fiber. This allows direct transmission of the idler photons from the demultiplexer to the detection unit.

In an alternative further development, it may be provided that the polarization compensation units are arranged between the outputs of the demultiplexer and the at least one second detection unit, preferably between the outputs of the demultiplexer and the inputs of the multiplexer. Such an arrangement can significantly improve the quality of the entangled state. By means of a polarization compensation unit after the output of the demultiplexer, compensation of the bases for the respective wavelength range of the photons can be provided.

In an alternative further development, it may be provided that the entangled photon source is designed to generate polarization-entangled photon pairs in a broad spectrum Δλ. It may be provided that the spectrum Δλ is at least 40 nm wide, preferably at least 100 nm wide. This has the advantage that a large number of entangled photon pairs can be generated in a single source and transmitted to the first and second receivers, respectively, thereby in-creasing the capacity of the QKD system and the optical fiber.

In an alternative further development, it may be provided that the spectrum Δλ of the entangled photon source has at least two wavelength channels λₙ, preferably one wavelength channel λᵢ per polarization compensation unit. Preferably, each wavelength channel λᵢ is between 0.3 nm and 1.6 nm wide. Preferably, the wavelength channels λᵢ can have wavelengths and channel spacing in accordance with the International Telecommunication Union (ITU). This has the advantage that standardized components can be used. At least two wavelength channels λₙ means here that two, or three, or four, or five or more wavelength channels λᵢ are formed.

Together with the arrangement of the source in the vicinity of the second receiver, or the higher losses or lower transmission rate to the first receiver, the polarization-entangled photon source with a broad spectrum and multiple wavelength channels has the advantage that the broad spectrum can be transmitted to the remote receiving station and detected with a single first detection unit. In order to generate a high key generation rate with high quality of the entangled state, it is advantageous to perform individual polarization compensation with the respective polarization compensation unit after each output of the demultiplexer, preferably before each second detection unit, in order to set the desired entangled state for each entangled photon pair of the multiple wavelength channels.

In an alternative further development, it may be provided that the first and/or second communication channel is designed as a fiber, and/or that a fiber for transmitting the idler photons is formed between the demultiplexer and the at least one second detection unit, preferably that the polarization compensation unit is arranged in the fiber in each case. This provides an easy-to-install and easy-to-maintain system for quantum key distribution (QKD).

In an alternative further development, it may be provided that the polarization compensation unit is designed as a fiber polarization compensation unit, preferably as a two or three in fiber paddle controller, and/or preferably as a fiber squeezer, and/or thermal polarization controller with a polarization-maintaining fiber piece (PM fiber) and/or as waveplates in a free-beam section. In an alternative further development, it may be provided that the polarization compensation unit is designed as a manual fiber polarization compensation unit or an automated fiber polarization compensation unit. This provides an easy-to-install and easy-to-maintain system for quantum key distribution (QKD).

In an alternative further development, it may be provided that each detection unit, preferably the first detection unit and/or the at least one second detection unit, each comprises a measuring unit for measuring the signal or idler photons in at least two mutually unbiased bases (MUB) and at least one detector, preferably two detectors, preferably four detectors, for detecting the signal or idler photons, after the measuring unit. The measuring unit may comprise one or more polarizing beam splitters and/or wave plates.

In an alternative further development, each detection unit may comprise one or more superconducting nanowire single-photon detectors (SNSPD) and/or one or more InGaAs single-photon detectors for detecting the entangled photons.

In an alternative further development, it may be provided that the detection unit is designed as a fiber detection unit or as a mixed fiber and free-beam detection unit. In this case, the measuring unit may, for example, be designed from fiber or free-space components, whereby the photons may also be guided to the respective detector in a fiber or in the open air.

In an alternative further development, it may be provided that the entangled photon source is designed with a nonlinear element as a Sagnac source, or a linear source, or a linear source with reflection, or a BBO source.

The object of the invention is further solved by a method for quantum key distribution (QKD) according to independent claim 15.

The method for quantum key distribution (QKD) according to the invention comprises the following steps:
Generating polarization-entangled photon pairs, each consisting of a signal photon and an idler photon, in an entangled photon source;
sending the signal photons or the idler photons to a first receiver and detecting the signal photons or the idler photons at the first receiver in a first detection unit;
sending the idler photons or the signal photons to a second receiver and detecting the idler photons or the signal photons at the second receiver in at least one second detection unit;
wherein, for the detection of the idler photons or the signal photons at the second receiver, the idler photons or the signal photons are first divided into at least two channels in a demultiplexer according to their wavelength, and in each channel, a polarization compensation is performed separately by a respective polarization compensation unit before the detection of the idler photons.

In a further development of the method, it may be provided that the idler photons or the signal photons are guided to the at least one second detection unit at the second receiver after polarization compensation, are measured in at least two mutually unbiased bases (MUB) and are detected in at least one detector.

The invention is described in more detail below with reference to the accompanying drawings:

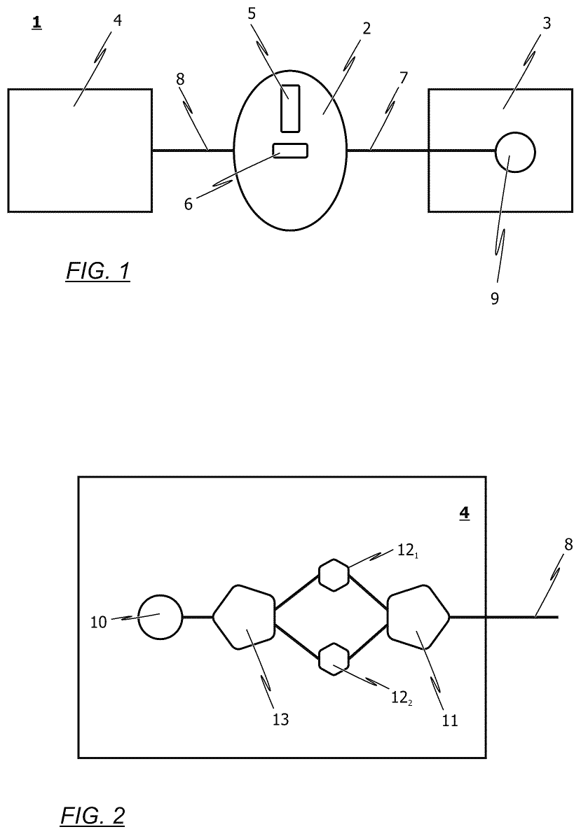

FIG. 1 schematic representation of the quantum key distribution (QKD) system;

FIG. 2 schematic representation of the second receiver with a second detection unit;

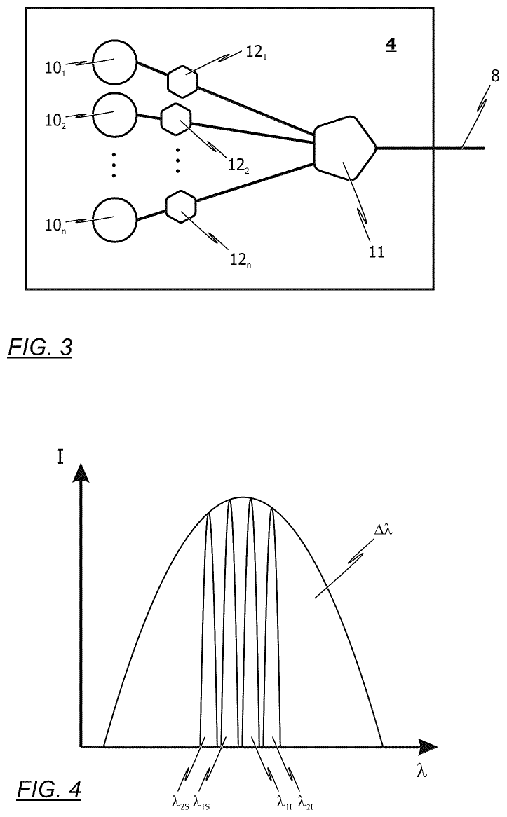

FIG. 3 schematic representation of the second receiver with several second detection units;

FIG. 4 schematic representation of the spectrum of the entangled photon source with multiple wavelength channels;

FIG. 5 improvement of the key generation rate as a function of the number of second detection units for superconducting nanowire single-photon detectors (SNSPD);

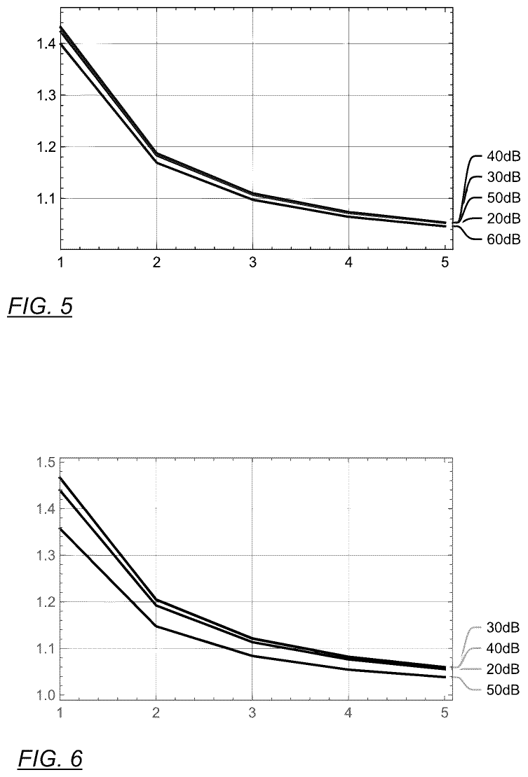

FIG. 6 improvement in key generation rate as a function of the number of second detection units for low-cost superconducting nanowire single-photon detectors (SNSPD);

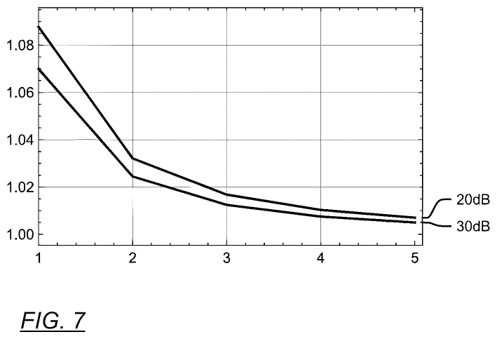

FIG. 7 improvement in key generation rate as a function of the number of second detection units for superconducting nanowire single-photon detectors (SNSPD) at the second receiver and InGaAs single-photon detectors at the first receiver.

FIG. 1 shows the quantum key distribution (QKD) system 1 according to the invention with an entangled photon source 2, a first receiver 3, and a second receiver 4. The entangled photon source 2 comprises a laser 5 and a nonlinear element 6 for generating polarization-entangled photon pairs, each with a signal photon and an idler photon. Alternatively, any other entangled photon source 2 can be used to generate polarization-entangled photon pairs, such as a quantum dot.

The entangled photon source 2 is connected to the first receiver 3 via a first communication channel 7 for transmitting the signal photons. The entangled photon source 2 is further connected to the second receiver 4 via a second communication channel 8 for transmitting the idler photons. Of course, the idler photons can alternatively also be transmitted to the first receiver 3 and the signal photons to the second receiver 4. This applies to all subsequent embodiments.

The first receiver 3 has a first detection unit 9 for measuring and detecting the signal photons, which preferably consists of a measuring unit (not shown in FIG. 1) and a detector, preferably two detectors, preferably four detectors (not shown in FIG. 1). The measuring unit allows the signal photons to be measured in at least two mutually unbiased bases (MUB) and are then detected in the one or more detectors.

A first embodiment of the second receiver 4 is shown in detail in FIG. 2. In this embodiment, the second receiver 4 has a demultiplexer 11 that is connected to the entangled photon source 2 via the second communication channel 8. The demultiplexer 11 can be designed as a dichroic mirror, grating, etalon, fiber etalon, or prism. Furthermore, the demultiplexer 11 has two outputs. The demultiplexer 11 can also have more than two outputs, preferably n outputs.

The demultiplexer 11 is used to distribute the polarization-entangled photons generated in the source in a broad spectrum Δλ to the multiple outputs of the demultiplexer 11. Each idler photon of the entangled photon pairs is assigned to an output according to its wavelength based on the respective wavelength channel λᵢ.

In the first embodiment of FIG. 2, the second receiver 4 comprises a second detection unit 10. In this embodiment, the demultiplexer comprises two outputs, with a polarization compensation unit 12 arranged after each output. A multiplexer 13 is formed after the polarization compensation unit 12, which recombines the multiple channels and directs the photons to the second detection unit 10. Of course, more than two outputs can also be formed on the demultiplexer 3, in which case the multiplexer recombines the multiple outputs onto one or more second detection units 10.

FIG. 3 shows a second embodiment of the second receiver 4. In this embodiment, the second receiver 4 comprises a second detection unit 10 for each output of the demultiplexer 11. The outputs of the demultiplexer 11 are each connected to one of the second detection units 10, whereby the second receiver 4 in the second embodiment of FIG. 3 comprises at least two second detection units 10, with n second detection units 10 being shown schematically in FIG. 3. The multiple second detection units 10 allow the entire spectrum of the generated entangled photon pairs to be used for key generation without saturating the detectors at the second receiver 4. A polarization compensation unit 12 is arranged in front of each detection unit 10 and thus after the respective output of the demultiplexer 11, wherein FIG. 3 schematically shows n polarization compensation units 12.

The polarization compensation units 12 of FIGS. 2 and 3 can be designed as fiber elements with two or three in fiber paddle controllers, thermal polarization controllers with a polarization-maintaining fiber piece (PM fiber), and/or as one or more fiber squeezers. It is also possible that the polarization compensation unit 12 consists of several waveplates in a free-beam section. The polarization compensation unit 12 is used to perform polarization compensation for its respective wavelength channel λᵢ so that the first receiver 3 and the second receiver 4 measure in the same bases. By using one polarization compensation unit 12 per wavelength channel λᵢ, the quality of the entangled state can be significantly improved, since each polarization compensation unit allows the bases to be compensated very precisely for each wavelength channel.

FIG. 4 schematically shows the spectrum Δλ of the entangled photon source, in which the signal photons and the idler photons are generated in their respective wavelength channels λ_{iS} and λ_{iI}. The wavelength channels of the signal photons are detected together in the first detection unit 9 at the first receiver 3. The wavelength channels of the idler photons are divided by the demultiplexer 11 at the second receiver 4 into the multiple polarization compensation units 12 and measured either in a second detection unit 10, as shown in FIG. 2, or separately in one of the second detection units 10, as shown in FIG. 3. Polarization compensation is performed for each wavelength channel at the second receiver 4 by the respective polarization compensation unit 12.

FIGS. 5 and 6 show the improvement in key generation rate as a function of the additional number of second detection units for superconducting nanowire single-photon detectors (SNSPD) (FIG. 5) and for inexpensive superconducting nanowire single-photon detectors (SNSPD) (FIG. 6) for different loss scenarios during the transmission of the signal photons to the first receiver 3. The number of additional second detection units 10 is shown on the X-axis. The improvement in the key generation rate is shown on the Y-axis of FIGS. 5 and 6. As shown in FIGS. 5 and 6, even with one additional second detection unit 10, i.e., with a total of two second detection units 10, an improvement in the key generation rate of al-most 50% (FIG. 6) and over 40% (FIG. 5) is achieved.

FIG. 7 shows the improvement in the key generation rate as a function of the additional number of second detection units 10 for InGaAs single-photon detectors at the first receiver 3 and for superconducting nanowire single-photon detectors (SNSPD) at the second receiver 4 for different loss scenarios during the transmission of the signal photons to the first receiver 3. In this embodiment, an improvement in the key generation rate of over 6% can be obtained with a total of two second detection units 10.

As shown in FIGS. 5 to 7, the improvement in the key generation rate also depends on the number of additional second detection units 10. The improvement decreases as more and more second detection units 10 are added.

The invention is not limited to the embodiments shown in the drawings, but results from a combination of all the features disclosed herein.

1. A system for quantum key distribution (QKD), comprising:
an entangled photon source for generating polarization-entangled photon pairs;
a first receiver;
a second receiver;
each polarization-entangled photon pair consisting of a signal photon and an idler photon;
the first receiver being connected via a first communication channel to the entangled photon source for transmitting the signal photons or the idler photons, the first receiver having a first detection unit; and
the second receiver being connected via a second communication channel to the entangled photon source for transmitting the idler photons or the signal photons, wherein the second receiver comprises a demultiplexer and at least one second detection unit, wherein the demultiplexer divides the idler photons or the signal photons according to their wavelength onto at least two outputs of the demultiplexer, and wherein a polarization compensation unit is arranged after each output of the demultiplexer.

2. The system according to claim 1, wherein the first receiver only comprises the first detection unit.

3. The system according to claim 1, wherein one or more of:
the transmission rate of the idler photons from the entangled photon source to the second receiver is greater than the transmission rate of the signal photons from the entangled photon source to the first receiver;
the losses of the signal photons from the entangled photon source to the first receiver are greater than the losses of the idler photons from the entangled photon source to the second receiver;
the first communication channel is longer than the second communication channel, and/or
the entangled photon source is located in the immediate vicinity of the second receiver.

4. The system according to claim 1, wherein the demultiplexer is designed as a wavelength-splitting element.

5. The system according to claim 4, wherein the wavelength-splitting element is comprised of one or more dichroic mirrors, or gratings, or prisms, or etalons, or fiber etalons, in order to split the idler photons according to their wavelength onto the at least two outputs of the demultiplexer.

6. The system according to claim 1, wherein a multiplexer is arranged upstream of the at least one second detection unit to combine the demultiplexed photons onto the at least one second detection unit, wherein the multiplexer is arranged downstream of the at least two polarization compensation units.

7. The system according to claim 1, wherein at least two second detection units are formed at the second receiver, wherein a polarization compensation unit is arranged in front of each of the second detection units.

8. The system according to claim 7, wherein a second detection unit is formed at the second receiver for each output of the demultiplexer.

9. The system according to claim 1, wherein the polarization compensation unit is arranged between the outputs of the demultiplexer and the at least one second detection unit, preferably between the outputs of the demultiplexer and the inputs of the multiplexer.

10. The system according to claim 1, wherein the entangled photon source is designed to generate polarization-entangled photon pairs in a broad spectrum Δλ.

11. The system according to claim 10, wherein the broad spectrum Δλ is one of:
at least 2 nm wide;
at least 5 nm wide; and
at least 10 nm wide.

12. The system according to claim 10, wherein the spectrum of the entangled photon source has at least two wavelength channels.

13. The system according to claim 12, where the at least two wavelength channels are arranged as one wavelength channel per polarization compensation unit.

14. The system according to claim 1, wherein one or more of:
the one or both first and second communication channel are designed as a fiber; and
a fiber for transmitting the idler photons is formed between the demultiplexer and the at least one second detection unit, the polarization compensation unit being arranged in the fiber in each case.

15. The system according to claim 1, wherein the polarization compensation unit is a fiber polarization compensation unit.

16. The system according to claim 15, wherein the fiber polarization compensation unit is one or more of:
a two or three in fiber paddle controller;
a fiber squeezer;,
waveplates in a free-beam section; and
a thermal polarization controller with a polarization-maintaining fiber piece (PM fiber).

17. The system according to claim 1, wherein the polarization compensation unit is a manual fiber polarization compensation unit or an automated fiber polarization compensation unit.

18. The system according to claim 1, wherein each detection unit comprises a measuring unit, for measuring the signal or idler photons in at least two mutually unbiased bases (MUB) and at least one detector for detecting the signal or idler photons, after the measuring unit.

19. The system according to claim 1, wherein the detection unit is designed as a fiber detection unit or as a mixed fiber and free-space detection unit.

20. A method for quantum key distribution (QKD), the method comprising:
generating polarization-entangled photon pairs, each consisting of a signal photon and an idler photon, in an entangled photon source;
sending the signal photons or idler photons to a first receiver and detecting the signal photons or idler photons at the first receiver in a first detection unit;
sending the idler photons or signal photons to a second receiver and detecting the idler photons or signal photons at the second receiver in at least one second detection unit; and
for the detection of the idler photons or signal photons at the second receiver, the idler photons or signal photons are first divided into at least two channels in a demultiplexer according to their wavelength, and in each channel, polarization compensation is performed separately by a respective polarization compensation unit prior to the detection of the idler photons.
